(19) United States
(12) Patent Application Publication
(10) Pub. No.: US 2015/0323070 A1
(43) Pub. Date: Nov. 12, 2015

(54) BRAKING SYSTEM

(71) Applicant: Caterpillar SARL, Geneva (CH)

(72) Inventors: Neil Taylor, Cramlington (GB); John Chapman, Peterlee (GB); Adam Adeeb, Plainfield, IL (US); David Richard Wisley, Peoria, IL (US); Jonathan Trawford, Bourne (GB); Samuel Alec Roberts, Hartlepool (GB); Stephen Thompson, Sunderland (GB); Andrew Colin Ellis, Gateshead (GB); John D. Gates, Oswego, IL (US)

(73) Assignee: Caterpillar SARL, Geneva (CH)

(21) Appl. No.: 14/274,095

(22) Filed: May 9, 2014

(51) Int. Cl. F16H 63/48; B60T 11/10

(52) U.S. Cl. CPC F16H 63/486; B60T 11/103

(57) ABSTRACT

The present disclosure relates to a braking system and, more particularly, to a braking system for engaging a brake mechanism as a waiting brake for a load carrying vehicle. The braking system utilises an electrohydraulic brake control mechanism comprising at least one automatic retard control valve to engage the brake mechanism, which is activated by a dual function apparatus which also controls another operation of the vehicle.

### TECHNICAL FIELD

The present disclosure relates to a braking system and, more particularly, to a braking system for engaging a brake mechanism as a waiting brake for a load carrying vehicle.

### BACKGROUND

Load carrying vehicles, including trucks, wheel loaders and the like, are commonly employed during construction and excavation for transporting loads from one point to another. The surface on which such vehicles operate is typically uneven with inclined surfaces (known as grades).

Load carrying vehicles generally have a “parking brake” system, which is intended for use when the vehicle is not being operated. In such situations the vehicle is brought to a halt on level ground, the parking brake is engaged, the engine is switched off and the vehicle operator (driver) leaves the cab. However there are a number of situations in which the vehicle must be stopped temporarily, with the engine still running with the operator remaining in the cab. Such temporary stops are required during or waiting for loading and dumping. For temporary stops, such vehicles are generally equipped with a “service brake” system, usually activated by the operator via a foot pedal. The loading and dumping operations may take place on a grade, which means that the operator may need to sit with their foot pressed against the service brake pedal for several minutes at a time.

US-A-2003/0111891 and US-A-2007/0150120 describes an operator controlled device for a load carrying vehicle which, in a single operation, activates the service brakes and obtains a neutral position of the gearbox. This obviates the need for the operator to keep his foot pressed on the parking brake. However, before the vehicle can move off, the operator has to first move the gear lever from the position it was in when the device was activated through neutral and into the intended forward or reverse gear.

### SUMMARY OF THE DISCLOSURE

According to the disclosure there is provided a braking system for a vehicle comprising:—
a brake mechanism;
an electrohydraulic brake control mechanism for activating the brake mechanism;
   said electrohydraulic brake control mechanism comprising at least one automatic retard control valve;
a user interface for requesting activation of the brake mechanism, said user interface being a dual function apparatus which also controls another operation of the vehicle; and
a controller configured to control the operation of the automatic retard control valve to activate the brake mechanism on determination of a request for activation of the brake mechanism applied by the user interface.

### BRIEF DESCRIPTION OF THE DRAWINGS

Preferred embodiments of the braking system will now be described, by way of example only, with reference to the accompanying drawings in which:—

FIG. 1 is a schematic illustrating the operation of the braking system;

FIG. 2 is a perspective view of cab controls showing a transmission lever of the braking system of FIG. 1;

FIG. 3 is a diagram of a brake control mechanism of the braking system of FIG. 1;

FIG. 4 is a diagram of the braking system of FIG. 1 in one operational mode;

FIG. 5 is a diagram of the braking system of FIG. 1 in another operational mode; and

FIG. 6 is a diagram of the braking system of FIG. 1 with the waiting brake function active.

### DETAILED DESCRIPTION

The braking system 10 of the present disclosure may be used in any vehicle, in particular a load carrying vehicle, including articulated or non-articulated vehicles.

The vehicle may comprise a chassis mounted on wheels, and an engine, or another form of power unit, connected to the wheels by a suitable transmission system. The transmission system may be an automatic transmission system. The transmission system may comprise a gearbox which is operated by a transmission gear select lever 16, which enables the operator to select an appropriate gear or transmission mode for the operation of the vehicle. The transmission modes may include a neutral mode, in which the gear trains within the transmission system are disconnected, and one or more drive modes, such as forward (which allows the gear ratio to change automatically), reverse or one or more specific gears.

The vehicle may comprise one or more electronic control units (ECUs) which have are configured to monitor operating parameters and to control operation of the various vehicle systems and components. These ECUs will be collectively referred to herein as a computer control unit 14.

The vehicle may comprise a cab mounted on the chassis, in which the operator sits, which houses the controls for the vehicle. The controls may include one or more brake actuators (such as pedals) 20, the transmission gear select lever 16, one or more hoist levers (for operating the vehicle's working equipment) and a steering wheel. The vehicle may comprise a body for carrying a load mounted on the chassis.

The vehicle may be provided with a number of different brake mechanisms 11 or braking functions, which are intended to be used under different conditions. In this specification the following terminology will be used:—
“parking brake” which is a brake mechanism intended for use when the engine is not running and the vehicle is unattended;
“service brake” which is a brake mechanism intended to be used for temporary stops whilst the operator is in the cab and the engine is running;
“engine compression brake” which is a brake mechanism used to assist in slowing down the vehicle; and
“waiting brake” which is a braking function also intended to be used for temporary stops whilst the operator is in the cab and the engine is running which may utilise one or more of the aforementioned brake mechanisms.

These brake mechanisms 11 may comprise a plurality of separate brakes associated with each wheel or some of the wheels of the vehicle. For example the brake mechanism 11 may comprise front brakes and rear brakes for the front and rear wheels of the vehicle respectively. The brake mechanisms may be operated by an operator controlled brake actuator, such as a pedal, switch or lever in a known manner.

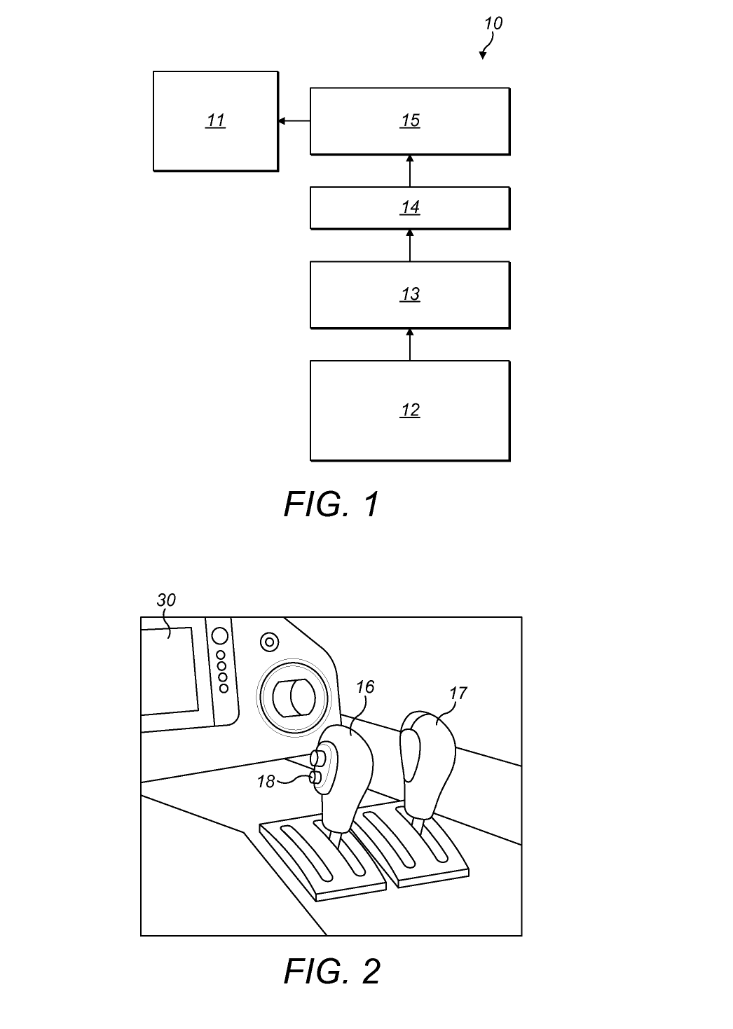

The operation of the braking system 10 is illustrated in its broadest sense in FIG. 1. The braking system 10 provides a waiting brake function which utilises a brake mechanism 11, which may be one or more of the parking brake, service brake or another form of brake. The waiting brake function may be requested by the operator at a user interface 12, for example by means of a button, switch, pedal, detent, or may be triggered automatically according to the machine state, as determined by the computer control unit 14. Software 13 may control the operation of the computer control unit 14, and may provide control logic for operation of the waiting brake function, based on signals received/provided by the computer control unit 14. The computer control unit 14 in turn may control an electrohydraulic brake control mechanism 15, which in turn may control the brake mechanism 11.

The control logic may use some or all of the following parameters:—
transmission output speed
engine speed
vehicle speed (which may be determined by the transmission output speed)
brake oil pressure
brake valve status
service brake actuator status
ignition status
rimpull level
transmission gear status
waiting brake user interface status

The control logic may be set such that the waiting brake function is only activated if the vehicle is stationery, or moving at a very low speed, for example less than 1 mph, and the transmission system is in neutral. The control logic may require that the engine is running, that the vehicle ignition is in the run position and that the vehicle has a speed of zero. The control logic may require that the engine speed has been above a pre-set minimum engine speed for a pre-set minimum period of time. The minimum engine speed may be 500 rpm and the minimum period may be 2 seconds. The control logic may require that no faults are detected within the braking system 10 and that low brake pressure is not detected within the braking system 10. The control logic may require that the transmission output speed is below a pre-set maximum transmission output speed, which may be 30 rpm.

In one embodiment, the waiting brake function may be requested by the operator by the user interface 12. FIG. 2 shows a transmission gear select lever 16 which may be located adjacent a hoist lever 17, which may operate other apparatus of the vehicle. The transmission gear select lever 16 may be provided with a switch 18, which may be a button or detent or other form of actuator mounted on the transmission gear select lever 16. The switch 18 is one example of a user interface 12. Other forms of user interface 12 may also be used. It is known for load carrying vehicles 10 with automatic transmission systems to be provided with a shift lock button, usually located on the transmission gear select lever 16, which holds the transmission in a specific drive mode, usually a specific forward gear. The switch 18 in the braking system 10 of the present disclosure may be a dual function device. The switch 18 may be a momentary switch. The switch 18, when activated when the transmission is in a drive mode, may act as such a shift lock button to prevent the transmission from changing into a different gear. The switch 18, when activated when the transmission system is in neutral mode, may activate the waiting brake function. When the switch 18 is activated when the transmission system is in neutral mode, the computer control unit 14 may send a signal to the brake control mechanism 15, which may cause the brake mechanism 11 which is used in the waiting brake function to engage.

The control logic may require that the switch 18, or other waiting brake user interface 12, is pressed and held for a minimum period, which may be 0.5 seconds, before the waiting brake function is activated.

The control logic may require that a brake mechanism 11, which may be the same or different to the brake mechanism 11 which is used in the waiting brake function, is engaged before the waiting brake function is activated.

The service brake 19 may be configured to retard motion of the vehicle and may be a hydraulic pressure-actuated wheel brake such as, for example, a disk brake or a drum brake. The service brake 19 may be manually actuated by the operator by means of a service brake actuator 20, such as a foot pedal. The control logic may require that the service brake actuator 20 is manually actuated by the operator to apply the service brake 19 before the waiting brake function is activated. Thus where the brake mechanism 11 which is used in the waiting brake function is the service brake 19, the engagement of the service brake 19 is manually initiated by the operator and then maintained by the waiting brake function when the operator releases the service brake actuator 20.

Alternatively, the service brake 19 may be automatically actuated by the computer control unit 14 when the waiting brake function is requested at the waiting brake user interface 12.

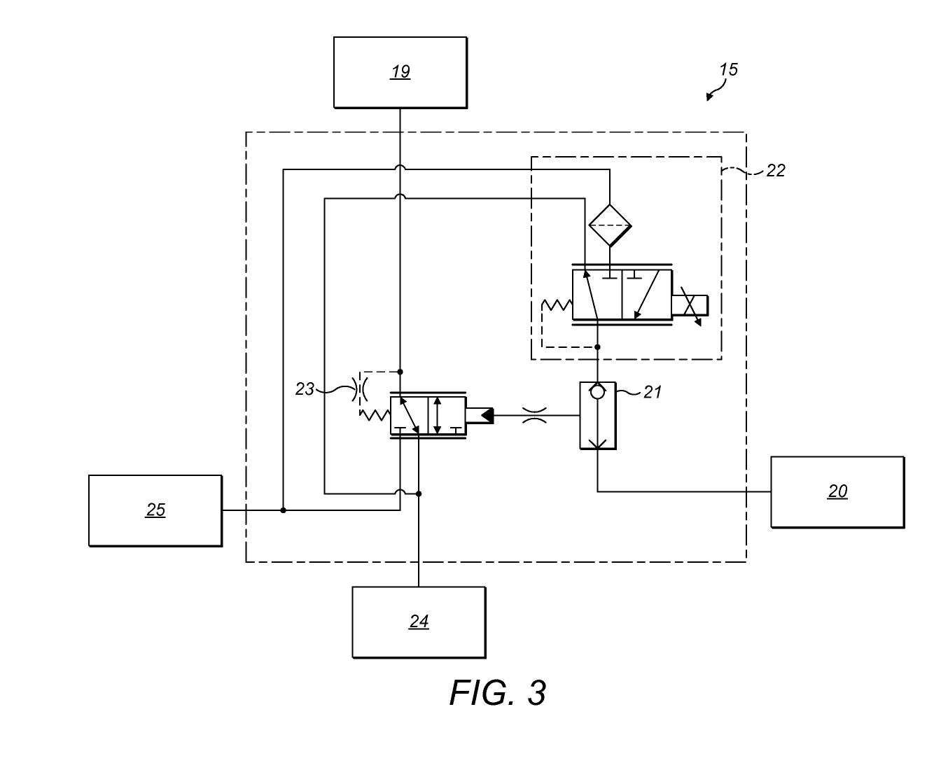

Control of the service brake 19, or another brake mechanism 11, to provide the waiting brake function may be effected by the brake control mechanism 15. The brake control mechanism 15 may comprise one or more valves, which may include at least one automatic retard control (ARC) valves 22, as illustrated in FIG. 3. On operation of the service brake actuator 20, or the actuator of another brake mechanism 11, an actuator pressure signal 26 may be supplied to a pressure resolver 21. An automatic retard control (ARC) valve 22, which may be a solenoid valve, may supply a proportional ARC valve pressure signal 27 to the pressure resolver 21 based on inputs to the computer control unit 14. The pressure resolver 21 passes the higher of the actuator and ARC valve pressure signals 26,27 to a pressure relay 23. The pressure relay 23 multiplies the output signal from the pressure resolver 21 by a ratio to provide a modified pressure signal, which is the brake pressure signal 28 which is sent to the service brake 19 or another brake mechanism 11. The brake control mechanism 15 may be supplied with pressurised hydraulic fluid (brake charge pressure 29) from a reservoir 24, such as a tank, by means of a pump 25.

Where the brake mechanism 11 comprises a plurality of separate brakes associated with each or some wheels of the vehicle, the brake control mechanism 15 may comprise an automatic retard control (ARC) valve 22 arranged to control each of the separate brakes. The brake control mechanism 15 may comprise additional valves controlled by the operation of the service brake actuator 20, or another brake actuator. These additional valves may control the service brake 19 (or other brake mechanism 11) directly or indirectly via the automatic retard control (ARC) valves 22.

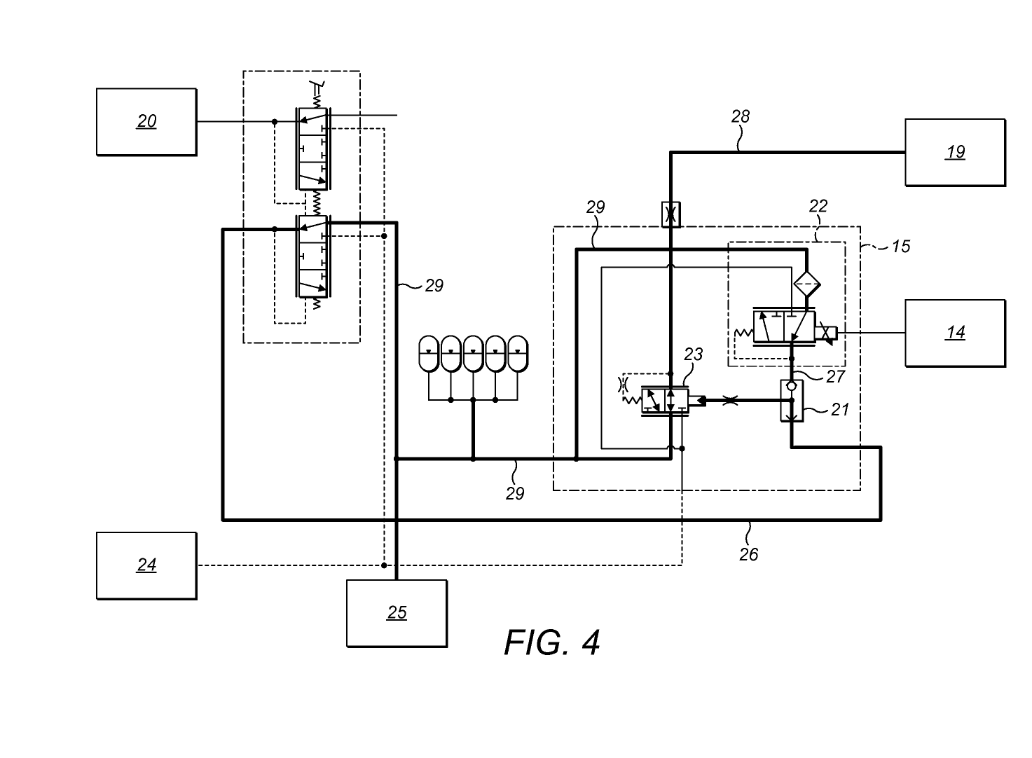

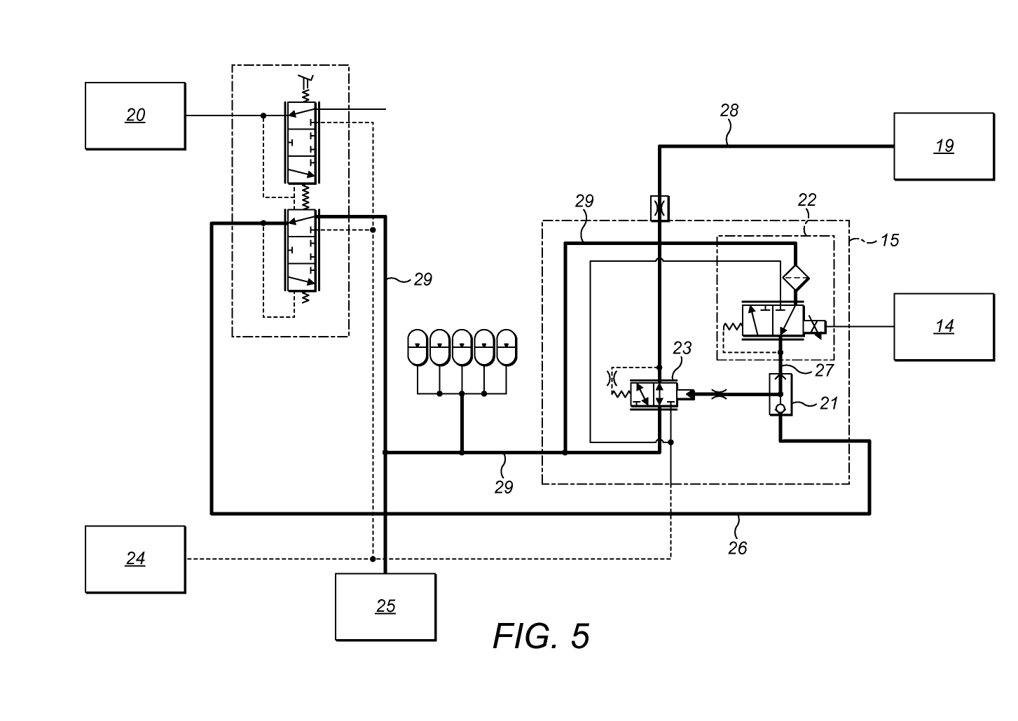

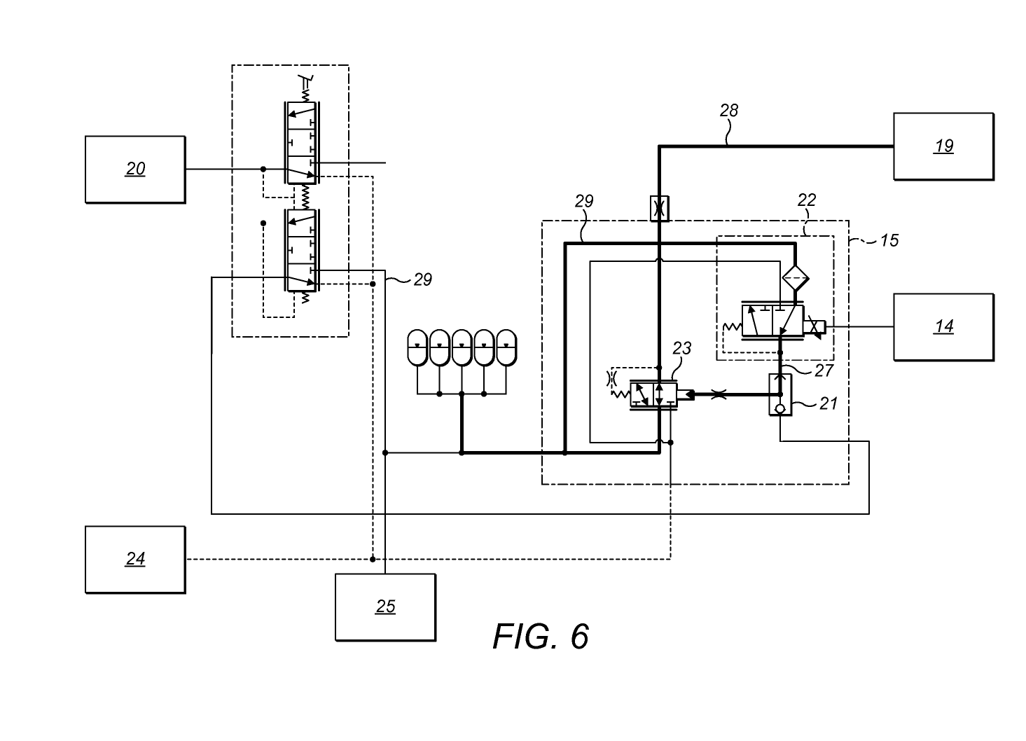

FIG. 4 illustrates the condition where the actuator signal pressure 26 is higher than the ARC valve pressure signal 27 and FIG. 5 illustrates the reverse condition. FIG. 6 illustrates the condition where the waiting brake function is active.

The waiting brake function may be disengaged in a number of different ways. The waiting brake user interface 12 may be deactivated manually by the operator before moving the transmission gear select lever 16 out of neutral mode into a drive mode. This may be effected by pressing the switch 18 or other waiting brake user interface 12, which will disengage the waiting brake function. The control logic may also require that the switch 18, or other waiting brake user interface 12, is pressed and held for a minimum period, before the waiting brake function is deactivated. A suitable minimum period may be 0.5 seconds. The control logic may also require that a brake mechanism 11 is applied before the switch 18, or other waiting brake user interface 12, is pressed.

Alternatively the operator may simply move the transmission gear select lever 16 out of neutral mode into a drive mode, and the movement of the transmission gear select lever 16 deactivates the waiting brake user interface 12.

The disengagement of the waiting brake function may also engage another vehicle control system, such as the Hill Start system described in US-A-2013/0238210. The Hill Start system only becomes active when the vehicle is stationary and a drive gear is selected. The brake mechanism 11 actuated by the Hill Start system remains engaged until the operator applies sufficient throttle to propel the vehicle up a grade on which the vehicle has been parked and the vehicle control system activates to prevent the vehicle from rolling down a grade.

The braking system 10 may be configured to ensure that a brake mechanism 11 is manually engaged by the operator by means of the appropriate brake actuator before the waiting brake user interface 12 can be deactivated. Thus, if the service brake 19 is the brake mechanism 11 used in the waiting brake function, the operator must apply the service brake actuator 20 to manually engage the service brake 19 before pressing the switch 18, which would otherwise disengage the service brake 19 as a waiting brake.

The waiting brake function may also be disengaged if the vehicle ignition is switched off. In this embodiment the braking system 10 may be configured to automatically apply the parking brake.

The vehicle may be provided with one or more displays 30, which may be conveniently located on the dash board. These displays may typically display key operational data, such as vehicle speed, engine speed, gear temperatures and the like. Another display 30 may provide a graphical interface, which may provide details of diagnostics or events or a rear camera view which is activated on reversing. The (or one) display 30 may provide an indication to the operator when the waiting brake function has been activated, for example by means of a status lamp. The braking system 10 may also be configured to provide a warning, for example an illuminated symbol on the display 30, an audible sound or a flashing light, if the waiting brake function has been engaged for a predetermined period. The (or one) display may also provide a warning message in the event of a system fault with the waiting brake function. Such a massage may include information on what the issue is, the severity of the fault and what action may be taken to resolve the issue.

The braking system 10 may comprise a failsafe mode. In this mode, the control logic may require that, if a brake mechanism 11 is engaged and one of a number of predetermined fault conditions is detected, an additional brake mechanism 11 may be automatically engaged by the computer control unit 14. For example, if the waiting brake function has been activated (which may be utilising the brake mechanism 11 of the service brake 19) and a predetermined fault condition is detected, the braking system 10 may automatically engage the parking brake. In another example, if the service brake 19 is engaged under operator control and a predetermined fault condition is detected, the braking system 10 may automatically engage the parking brake. The brake mechanism 11, which is engaged when the predetermined faults condition is detected, may be automatically disengaged when the additional brake mechanism 11 is engaged.

The predetermined fault conditions may be detected by the computer control unit 14 and may be the failure of a component, such as a valve failure or a hydraulic pipe burst, which would result in a detectable change in the braking system pressure. The predetermined fault condition may be the failure of a vehicle system or sub-system. The predetermined fault condition may be that the engine speed drops below a threshold speed or shuts down, as lack of engine operation may automatically deactivate a brake mechanism 11 such as the waiting brake function. The predetermined fault condition may be that the ground speed of the vehicle is above a minimum pre-set speed for a pre-set minimum period of time. The minimum pre-set transmission output speed may be 500 rpm and the minimum period of time may be 1 second. The predetermined fault condition may be that the brake pressure of the engaged brake mechanism 11 drops below a predetermined threshold.

Information relating to the predetermined fault condition may be displayed on the display 30.

### INDUSTRIAL APPLICABILITY

If the operator of the vehicle wishes to come to a temporary stop, he may slow the vehicle down initially, using the compression brake. To complete the stopping process, the operator may manually engage a brake mechanism 11, such as the service brake 19, by operating an actuator such as the service brake actuator 20. When the vehicle is stationery or moving at a very slow speed, the operator may then move the transmission gear select lever 16 to put the transmission system into neutral mode and engage the waiting brake function by activating the switch 18 or other user interface 12. If the computer control unit 14 determines that the required conditions are met, according to the control logic, the waiting brake function may be engaged. FIG. 6 illustrates the condition when the waiting brake function is active. The computer control unit 14 maintains engagement of the brake mechanism 11 used in the waiting brake function, to enable the operator to release the service brake actuator 20 or other actuator. The vehicle may now be held stationery, whether it is stopped on a grade or a relatively flat surface, without the operator having to hold down the service brake actuator 20 or other actuator.

When the wait is over, and the operator wishes to move off, he may be required to maintain engagement of the brake mechanism 11 used in the waiting brake function by depressing the service brake actuator 20 or other brake actuator. He may then disengage the waiting brake function by deactivating the switch 18 or other user interface 12 and release the service brake actuator 20 or other brake actuator. Thus all brake mechanisms 11 are released enabling the vehicle to move off.

Alternatively he may simply select the appropriate drive mode by means of the transmission gear select lever 16 which automatically deactivates the switch 18 or other user interface 12 and disengages the waiting brake function. This enables the vehicle to move off.

Another vehicle control system, such as a Hill Start system, may be activated by the disengagement of the waiting brake function by means of the switch 18, or other user interface 12, or selecting a drive mode.

1. A braking system for a vehicle comprising:—
a brake mechanism;
an electrohydraulic brake control mechanism for activating the brake mechanism;
said electrohydraulic brake control mechanism comprising at least one automatic retard control valve;
a user interface for requesting activation of the brake mechanism, said user interface being a dual function apparatus which also controls another operation of the vehicle; and
a controller configured to control the operation of the automatic retard control valve to activate the brake mechanism on determination of a request for activation of the brake mechanism applied by the user interface.

2. A braking system as claimed in claim 1 in which the at least one automatic retard control valve is a solenoid valve.

3. A braking system as claimed in claim 1 in which the dual function device is configured such that:—
when the dual function device is activated when a transmission system of the vehicle is in a drive mode, the transmission system is maintained in that drive mode; and
when the dual function device is activated when the transmission system is in the neutral mode, the brake mechanism is engaged.

4. A braking system as claimed in claim 1 in which the controller comprises at least one electronic control unit arranged to monitor one or more operating parameters of the vehicle.

5. A braking system as claimed in claim 1 in which the controller comprises at least one electronic control unit arranged to control operation of the vehicle.

6. A braking system as claimed in claim 1 further comprising a second user interface in which the brake mechanism is activated by the first user interface to provide a first brake function and by the second user interface to provide a second brake function.

7. A braking system as claimed in claim 1 further comprising a pressure resolver.

8. A braking system as claimed in claim 7 wherein the pressure resolver is arranged to receive pressure signal resulting from operation of the first and second user interface and to pass the higher of the pressure signals to the brake mechanism.

9. A braking system as claimed in claim 8 in which the pressure resolver passed the higher of the pressure signals to a pressure relay which modifies the pressure signal and passes a modified pressure signal to the brake mechanism.

10. A braking system as claimed in claim 1 in which the brake mechanism comprises at least one service brake.

11. A braking system as claimed in claim 10 in which the brake mechanism comprises front service brakes and rear service brakes.

12. A braking system as claimed in claim 10 in which the second user interface is a service brake pedal.
